(19) United States
(12) Patent Application Publication
(10) Pub. No.: US 2010/0064584 A1
(43) Pub. Date: Mar. 18, 2010

(54) HYDROGEN GENERATOR

(76) Inventors: In Tae Bae, Wrentham, MA (US); Matthew R. Stone, Oxford, MA (US); Christopher R. LeClerc, Peabody, MA (US)

Correspondence Address: FISH & RICHARDSON P.C., P.O. BOX 1022, MINNEAPOLIS, MN, 55440-1022, US

(21) Appl. No.: 12/209,641

(22) Filed: Sep. 12, 2008

(51) Int. Cl. C01B 3/34

(52) U.S. Cl. 48/61

(57) ABSTRACT

A hydrogen generator includes a magnetically activated actuator that automatically adds a solid hydrogen source into a liquid in response to a variation in hydrogen pressure within the hydrogen generator. The solid hydrogen reacts with the liquid to generate hydrogen.

### TECHNICAL FIELD

This invention relates to a hydrogen generator.

### BACKGROUND

An electrochemical cell is a device capable of providing electrical energy from an electrochemical reaction, typically between two or more reactants. Generally, an electrochemical cell includes two electrodes, called an anode and a cathode, and an electrolyte disposed between the electrodes. In order to prevent direct reaction of the active material of the anode and the active material of the cathode, the electrodes are electrically isolated from each other by a separator.

In one type of electrochemical cell, sometimes called a hydrogen fuel cell, the anode reactant is hydrogen gas, and the cathode reactant is oxygen (e.g., from air). At the anode, oxidation of hydrogen produces protons and electrons. The protons flow from the anode, through the electrolyte, and to the cathode. The electrons flow from the anode to the cathode through an external electrical conductor, which can provide electricity to drive a load. At the cathode, the protons and the electrons react with oxygen to form water. The hydrogen can be generated from a hydrogen storage alloy, by ignition of a hydride, or by hydrolysis, for example, of a liquid solution or slurry of a hydride.

### SUMMARY

The invention generally features a hydrogen generator that includes a housing, a solid hydrogen source (e.g., a borohydride), a liquid including a proton source (e.g., water) and a metal salt to which the solid hydrogen source is added to generate hydrogen, and an outlet configured to deliver hydrogen to a hydrogen fuel cell.

In one aspect of the invention, the metal salt is a metal sulfate salt, for example, a transition metal sulfate salt. The metal sulfate salt does not generate corrosive gases during use in the generator.

In another aspect of the invention, the liquid include from 0.2 M to 0.4 M of the metal salt. It has been found that this concentration range produces a large amount of hydrogen gas at a high generation rate. The relatively low ion concentration of the metal salt provides a balance between producing a sufficient amount of catalyst from the metal salt and providing enough of the hydrogen source to participate in the hydrogen generation reaction.

In another aspect of the invention, pellets containing the solid hydrogen source are included within the housing and a magnetically activated actuator automatically adds one of the pellets to the liquid in response to a variation in hydrogen pressure within the hydrogen generator. The magnetically activated actuator provides an effective approach for adding a pellet to the liquid at the appropriate time.

In another aspect of the invention, a weight ratio of the solid hydrogen source to the liquid is less than 1:3. The controlled weight ratio allows generation of hydrogen gas at a high efficiency.

Various combinations of the above aspects of the invention can be used. In addition, embodiments can include one of more of the following features. When pellets are used, each pellet can include between 80% and 99.9% by weight of the solid hydrogen source, and each pellet can generate from about 50 cm³ to about 1500 cm³ of hydrogen when added into the liquid. The weight ratio between the solid hydrogen source and the liquid can be larger than 1:5. For each cubic centimeter of liquid stored in the hydrogen generator, about 0.2 gram to about 0.7 gram of solid hydrogen source, for example, sodium borohydride, is stored. Generated hydrogen can be delivered from the outlet at a rate of about 250 cm³/minute to a laptop that has a power consumption of about 20 W to about 25 W. When the generator includes a reservoir, the reservoir can include a buffer space above the liquid. The buffer space can have a volume of about 50 cm³ to about 1500 cm³. When a magnetically activated actuator is used, the generator can also include a first air passage from the buffer space to the outlet and a second air passage connected to the first air passage and in communication with the magnetically activated actuator. The magnetically activated actuator can include a first movable magnet having a first pole and a second magnet having a second pole facing the first pole, the first pole being the same as the second pole. The magnetically activated actuator can also include an air cylinder having a movable plunger. The plunger can include a first end connected to the first magnet and a second end in communication with the generated hydrogen. The plunger and the first magnet can move in response to the variation in hydrogen pressure. The magnetically activated actuator can also include a movable cradle and a spring. The cradle can have a first end connected to the second magnet and a second end connected to the spring. The cradle can move horizontally. The cradle can be configured to receive a pellet from the open end of the housing when the hydrogen pressure decreases. The cradle can also be configured to unload a pellet into the reservoir when the hydrogen pressure decreases.

The invention also features a second hydrogen generator that includes a housing, a solid hydrogen source (e.g., a borohydride) within a chamber in the housing and a first reservoir containing a liquid including a proton source (e.g., water) and a metal salt that when combined with the solid hydrogen source generates hydrogen and including an outlet valve that releases the solution in a controlled manner. The hydrogen generator further includes a second reservoir that receives the liquid from the first reservoir through the outlet valve, a control valve associated with the second reservoir that controls release of the liquid from the second reservoir to the chamber when the solution in the second reservoir reaches a certain height, and an outlet configured to deliver hydrogen to a hydrogen fuel cell.

Embodiments of the second hydrogen generator may also include the following features. The control valve can be pressure sensitive and can control the release of the liquid in response to a variation in a pressure of the hydrogen. The hydrogen generator can also include a U-tube in communication with the second reservoir and the chamber. The control valve can be in communication with the U-tube to control flow of the liquid from the second reservoir to the chamber. The control valve can also be in communication with the internal pressure of the hydrogen generator and controls the release of the liquid in response to a variation in the internal pressure. The control valve can include a plunger movable along a direction different from a flow direction of the liquid from the second reservoir to the chamber. The plunger can include a recessed portion that allows the liquid to pass the valve when aligned with a cross-section of a passage in which the liquid flows. The recessed portion can have dimensions smaller than dimensions of the cross-section of the passage. The control valve can also include a spring adjacent to the plunger along a direction in which the plunger moves and a elastic membrane between the spring and the plunger.

Embodiments of the second hydrogen generator may also include one or more of the features associated with the first featured hydrogen generator.

In other aspects, the invention also features methods of making and using the hydrogen generators described above.

The hydrogen generators described above can generate a good amount of hydrogen at a desired rate, for example, 250 cm³/minute for use in a laptop computer that requires a power supply, for example, ranging between 15 W and 25 W.

All publications, patent applications, patents, and other references mentioned herein are incorporated by reference herein in their entirety.

Other features and advantages of the invention will be apparent from the following detailed description, and from the claims.

### DESCRIPTION OF DRAWINGS

FIG. 1 is a schematic view of a hydrogen generator.

FIG. 2 is a plot of hydrogen generation rate at different metal sulfate salt concentrations.

FIG. 3 is a plot of hydrogen generation efficiency at different metal sulfate salt concentrations.

FIG. 4 is a plot of hydrogen generation efficiency for pellets added in sequence.

FIG. 5 is a schematic view of another hydrogen generator.

FIG. 6 is a schematic view of a control valve.

Like reference symbols in the various drawings indicate like elements.

### DETAILED DESCRIPTION

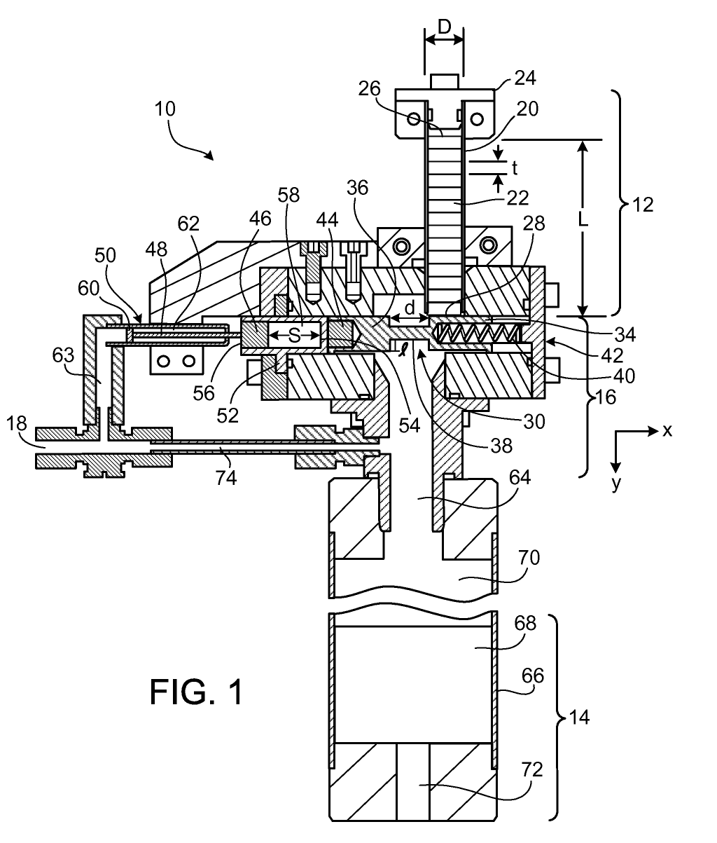

Referring to FIG. 1, a hydrogen generator 10 includes a storage unit 12 that holds a solid hydrogen source in the form, for example, of stacked pellets 22, a magnetically activated actuator 16 that automatically feeds the pellets 22 into a generation unit 14 where hydrogen gas is generated, and a gas outlet 18 that delivers the generated hydrogen gas from generation unit 14 to a device, for example, a hydrogen fuel cell, external to hydrogen generator 10.

Storage unit 12 includes a housing 20 having an internal chamber holding pellets 22. Housing 20 is in the shape of a tube having two ends 26 and 28. End 26 is sealed with a top cap 24. End 28 is open. Tubular housing 20 is vertically arranged and has open end 28 facing magnetically activated actuator 16. Because of gravity, a pellet 22 sits at open end 28 and is in contact with a portion of magnetically activated actuator 16 located beneath open end 28.

Tubular housing 20 has a length L, for example, of about 1 cm to about 30 cm and a diameter D, for example, of about 1 cm to about 20 cm. Housing 20 can be made of a metal, such as nickel or nickel plated steel, stainless steel, or aluminum-clad stainless steel, or a plastic, for example, polycarbonate, polyvinyl chloride, polypropylene, a polysulfone, acrylonitrile butadiene styrene, or a polyamide.

Pellets 22 can be formed by pressing a powder of the hydrogen source. Each pellet 22 has a diameter, for example, of about 0.4 cm to about 1.5 cm, a thickness t, for example, of about 0.3 cm to about 1.0 cm, and a total volume of about 0.12 cm³ to about 1.5 cm³, for example, about 0.2 cm³. In some embodiments, each pellet 22 weighs about 0.12 g to about 1.5 g, for example, 0.2 g. Pellets 22 are easy to handle and are resistant to impact.

Magnetically activated actuator 16 includes a delivery shuttle 30 that is movable back and forth along a direction x. Direction x is horizontal and perpendicular to the 20 feeding direction y of pellets 22.

Delivery shuttle 30 includes two U-shaped elements 34 and 36 connected by a cradle 38 along the x direction. Cradle 38 has a length d equal to or larger than the diameter of each pellet 22 and has a recessed depth l, with respect to U-shaped elements 34 and 36. For example, length d is about 0.5 cm and depth l is about 0.8 cm. Cradle 38 25 can be in the form of a bar and has a width (not shown) smaller than the diameter of each pellet 22, for example, about 0.16 cm and a length larger than the diameter of each pellet 22, for example, about 0.5 cm to about 0.7 cm. When delivery shuttle 30 moves and cradle 38 is vertically beneath open end 28 of housing 20 (not shown), a pellet 22 is loaded onto the cradle. When cradle 38 with the loaded pellet 22 is above a plenum space 64 that is connected to generation unit 14, the loaded pellet 22 unloads from cradle 38 and passes plenum space 64 to generation unit 14.

The bottom of the U-shaped element 34 is in contact with an end of a spring 40. The other end of spring 40 is fixed to a spring cap 42. A magnet 44 is fixed to the bottom of the U-shaped element 36 and can move back and forth along the x direction with delivery shuttle 38. Another magnet 46 fixed to a plunger 48 of an air cylinder 50 is placed at a distance S from magnet 44 along the x direction opposite to delivery shuttle 30. Magnets 44 and 46 have the same poles, for example, south or north, facing each other so that within a certain distance S, a repulsive force repels magnets 44 and 46 away from each other. In some embodiments, the two magnets 44 and 46 are separated by a tubular shaped separator 52 made, for example, of about 1.5 cm.

Separator 52 can have a sealed end 54 adjacent to delivery shuttle 30 and magnet 44 and an open end 56 to allow magnet 46 to move. In some embodiments, the size of magnet 46 matches the size of open end 56 of separator 52 so that a chamber 58 containing air is formed between magnet 46 and sealed end 54 of separator 52. Plunger 48 has an end 60 that seals air in a chamber 62 within air cylinder 50. External to chamber 62 and adjacent to end 60 is an air passage 63 that is connected to the reservoir and air passages of generation unit 14.

Before magnetically activated actuator 16 is in use, the balance state and working conditions of the feeding of pellets 22 are selected. For example, the amount and pressure of air in chambers 58 and 62, the sizes, distance S, and magnitude of the repulsive forces between magnets 44 and 46, the location of cradle 38, and the spring constant and starting deformation state of spring 40 are pre-selected. In use, the location of cradle 38, and therefore, delivery of the pellets 22 is subject to change based on the air pressure change in air passage 63, which is associated with the hydrogen gas production from generation unit 14 and consumption from external use.

Generation unit 14 includes a reservoir 66 that contains a liquid 68. Liquid 68 includes a proton source. During operation, hydrogen gas is produced when a pellet 22 is dropped into reservoir 66 and reacts with the proton source. In some embodiments, liquid 68 also includes a metal salt that facilitates the reaction between the proton source and pellets 22. Liquid 68 can be replenished from a addition port 72 located, for example, beneath the reservoir 66.

Generation unit 14 also includes a buffer space 70 in reservoir 66, above liquid 68, and beneath passage 64. Buffer space 70 can have a volume, for example, of between 50 cm³ and 150 cm³ (e.g., about 100 cm³). The air pressure in buffer space increases when more hydrogen gas is generated than is consumed and decreases when more hydrogen gas is consumed than is generated. In some embodiments, buffer space 70 provides a storage pressure of about 5 psig to about 90 psig, for example, 60 psig. The storage pressure can be selected based on a demand of the external fuel cell for the hydrogen gas, which can depend on the power that the fuel cell generates. For example, a 30 W fuel cell needs a supply of hydrogen gas at about 250 cc/min. Buffer space 70 provides storage volume for generated hydrogen gas from the reservoir and mitigates the pressure change within generator 10 and allows a continuous and smooth supply of hydrogen gas to the external hydrogen fuel cell and a smooth pressure change within generator 10 during, for example, intermittent generation of the hydrogen gas.

Gas outlet 18 is connected to buffer space 70 through an air passage 74. In some embodiments, a filter made, for example, of fiber felt or paper, is attached to the gas outlet 18. Air passage 74 is also in connection with air passage 63 so that the air pressure in air passage 63 increases and decreases in accordance with the increment and decrement of air pressure in buffer space 70. This design allows magnetically activated actuator 16 to move in response to pressure changes in air passage 63 resulting from the hydrogen gas from buffer space 70. For example, when the air pressure in air passage 63 is high, cradle 38 is pushed toward the stack of pellets 22 and a pellet 22 is loaded onto cradle 38. After release of hydrogen gas from outlet 18, the air pressure in air passage 63 drops and cradle 38 is pushed back to above passage 64 by spring 40 and the loaded pellet 22 is unloaded into reservoir 66 to react with the proton source in liquid 68. More hydrogen gas is generated and the processes described above repeat.

In some embodiments, hydrogen generator 10 is configured to allow a pellet 22 to be loaded onto delivery shuttle 38 when the air pressure in air passage 63 reaches, for example, 40 psig, and a loaded pellet 22 to unload from delivery shuttle 38 into generation unit 14 when the air pressure in air passage 63 reaches, for example, 20 psig. The feeding of pellets 22 is actuated at such pressures so that generation of hydrogen gas is kept at a higher rate than the consumption rate and a sufficient amount of hydrogen gas is stored in hydrogen generator 10 in case an instantaneous increase in consumption rate appears. The automated hydrogen generator 10 can provide a substantially continuous hydrogen delivery to the external device, for example, by feeding pellets 22 one by one into generation unit 14.

Pellets 22 can include a solid hydride, such as an alkali or alkaline earth hydride, an aluminum hydride, or a borohydride. The borohydride can be lithium borohydride, sodium borohydride, potassium borohydride, or mixtures thereof. In some cases, pellets 22 can include an oxidizable material, such as a metal (e.g., zinc, aluminum, titanium, zirconium, or tin). In some embodiments, the pellet 22 can be made by applying a high pressure, for example, 15000 psi, to a powder and can include a high density of solid hydride, for example, greater than 98% of theoretical density of 1.074 g/cm³ for sodium borohydride. In general, a pressure ranging between 400 psi and 20000 psi can be applied to a powder to produce a pellet having a density of about 0.67 g/cm³ to about 1.06 g/cm³. In some embodiments, each pellet contains about 80% about 99.9%, e.g., about 97% to about 98%, by weight of solid hydride. Each pellet 22 can generate, for example, between 50 cm³ and 1500 cm³ (e.g., between 200 cm³ and 800 cm³, e.g., 730 cm³) of hydrogen gas on average. For example, a pellet 22 having a total volume of about 0.2 cm³ can generate about 500 cm³ of hydrogen gas when it is fully used.

Pellets 22 can also include a binder. Examples of binders include polyethylene powders, polyethylene oxide, polypropylenes, polybutylenes, nylons, polyacrylamides, polyacrylates, polyvinyl chlorides, polystyrenes, polymethylpentenes, Portland cements, or fluorocarbon resins, such as polyvinylidene fluoride or polytetrafluoroethylene. In certain embodiments, the binder can be a hydrophilic material, such as a fibrous polymer fabric (e.g., polyvinyl alcohol fibers). Each pellet 22 can include, for example, between 0.01% and 10% binder by weight. Discussion of solid hydrogen source is also provided in U.S. Pat. No. 7,344,571 and U.S. Ser. No. 11/970,049, filed Jan. 7, 2008.

The proton source can be, for example, water. The metal salt can be, for example, a transition metal salt, such as a ruthenium salt, a palladium salt, a nickel salt, a copper salt, an iron salt, cobalt salt, or mixtures thereof. Preferred metal salts include metal sulfate salts. Examples of the metal sulfate salt include transition metal sulfate salts, such as cobalt sulfate, iron sulfate, copper sulfate, and nickel sulfate. Other metal salts, for example, metal chlorides can also be used. A metal catalyst can be generated in situ from the metal salts as discussed in detail below. The metal catalyst can activate the reaction of water with the borohydride in pellet 22 to generate hydrogen. In particular, the metal sulfate salt produces metal catalysts without generating corrosive gases, such as hydrogen chloride. The metal sulfate salt can be easily stored and be kept chemically stable, for example, under heat, e.g. generated during reactions, for a long time.

When a pellet 22 containing, e.g., sodium borohydride is added into liquid 68 containing water and the metal salt, e.g., cobalt sulfate, a catalyst, for example, cobalt is generated in situ by reducing the metal ion of the metal salt in a catalyst generation reaction as follows:

BH₄⁻+4Co²⁺+2H₂O→BO₂⁻+4Co+8H⁺ (1)

Concurrent to the generation of the catalyst, hydrogen is generated, for example, on surfaces of the catalyst, in a hydrogen generation reaction expressed as follows:

BH₄⁻+2H₂O→BO₂⁻+4H₂ ↑. (2)

Without being bound by theory, it is believed that the generation rate of hydrogen gas is associated with the reaction rate and the amount of the reactants that participates in the hydrogen generation reaction expressed in equation (2). It is also believed that the reaction rate is proportional to the total surface area of the catalyst with which the reactants are in contact and the concentration of each reactant in contact with the surface of the catalyst. Further, it is believed that the generation of catalyst in the reaction expressed in equation (1) consumes the hydride reactant without generating hydrogen gas.

In some embodiments, liquid 68 include a concentration of metal sulfate salt, for example, of at least about 0.05 M, 0.1 M, 0.15 M, 0.2 M, 0.25M, 0.3 M, and/or up to about 1.0 M, 0.9 M, 0.8 M, 0.7 M, 0.6 M, 0.5 M, or 0.4 M. In particular, when the concentration of the metal sulfate salt is about 0.2 M to about 0.4 M, a large amount of hydrogen gas is generated at a high generation rate, for example, 250 cm³/minute and a high efficiency. The low concentration of the metal salt provides a balance between producing a sufficient amount of catalyst for the hydrogen generation reaction and leaving a large amount of hydride to participate in the hydrogen generation reaction.

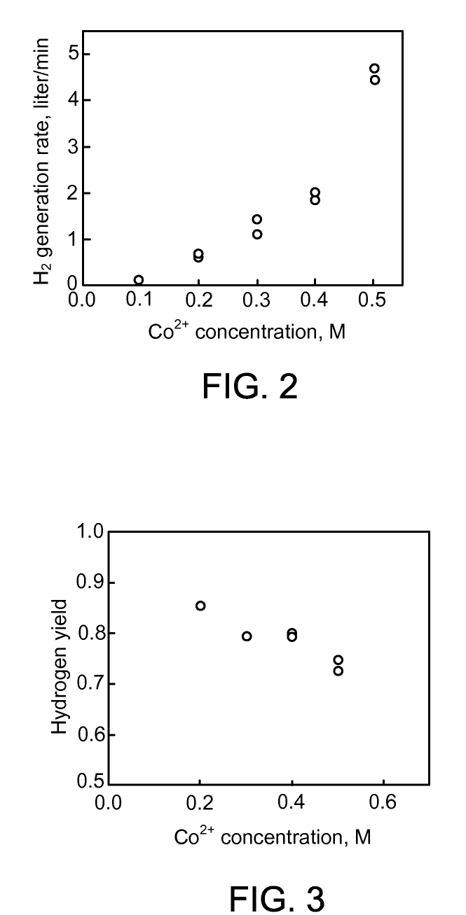

Referring to FIGS. 2 and 3, hydrogen generation rate and efficiency are measured when a pellet containing sodium borohydride and weighing about 0.5 g as discussed above is added into a solution having a total volume of about 10 cm³ and containing a cobalt sulfate with varying concentrations. Hydrogen generation efficiency, as defined herein, is the amount of hydrogen actually generated divided by the amount of hydrogen that theoretically should be generated. The concentration of metal sulfate salt is quantitatively related to the hydrogen generation rate, the total amount of hydrogen, and the hydrogen generation efficiency. In the example shown in the figures, the hydrogen generation rate increases nonlinearly with the concentration of metal sulfate salt. The parasitic loss of hydrogen also increases with the concentration of metal sulfate salt because the sodium borohydride is consumed in reducing the cobalt sulfate, as discussed above. Accordingly, the hydrogen generation efficiency decreases after the concentration of metal sulfate reaches a certain high value, for example, larger than 0.4 M.

Hydrogen generator 10 can store a number of pellets 20, and therefore an amount of hydride, proportional to an amount of liquid 68 so that when the stored hydride is fully used and without replenishing liquid 68, hydrogen gas is generated at a high efficiency for each pellet 20. In some embodiments, the weight ratio of hydride reactant to water in liquid 68 is about 1:1 to about 1:5, for example, between 1:3 and 1:5. Preferably, hydrogen generator 10 stores, for example, 0.2 gram to 0.7 gram (e.g., about 0.31 gram) of hydride reactant for each cubic centimeter of water or salt solution contained in the generator.

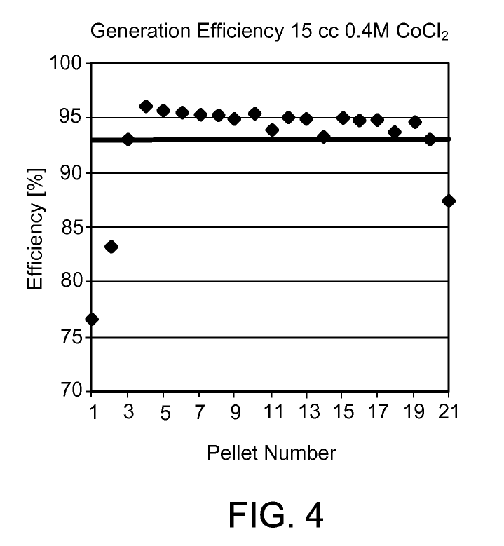

Referring to FIG. 4, twenty-one pellets 20 and 15 cm³ of cobalt fluoride solution at a concentration of about 0.4 M are stored in hydrogen generator 10 and the hydrogen generation efficiency when each pellet is added into the solution is measured and plotted. Each pellet 20 contains sodium boron hydride and on average, every 0.307 gram of the stored sodium boron hydride corresponds to 1 cm³ of the stored solution. Hydrogen is generated at an average efficiency of about 93.2% for all twenty-one pellets. In particular, hydrogen is generated at a efficiency higher than 93% for each of the third to the twentieth pellets added into the solution.

Pre-determined ratio of hydride (or pellet 20) to water (or salt solution) aliquot can be packaged into many units. One or more units can be loaded into hydrogen generator 10. The use of each unit can be controlled, for example, by a pressure fit adaptor. An efficient use of both water and hydride, for example, an increased volumetric energy density and a minimized amount of water used for a given amount of hydride, can be achieved. In addition, hydrogen generator 10 can be turned off and the packed units are feasible for long-term storage.

### EXAMPLE

In this illustrative example, hydrogen generator 10 is used to generate hydrogen gas for use in a hydrogen fuel cell that provides power supplies to a laptop computer, which has a power consumption of about 20 W to about 25 W.

65 cm³ metal salt solution including cobalt sulfate at a concentration of about 0.4 M is contained in the reservoir of the hydrogen generator. 25 pellets, each containing sodium boron hydride and weighing about 0.31 gram, are stacked in the housing of the hydrogen generator. The total volume of the buffer space, gas passages, and other space in the generator is about 125 cm³. Pellets are added in sequence into the solution and each pellet reacts with the solution for about 15 seconds to about 30 seconds. On average, each pellet generates about 730 cm³ of hydrogen gas. The overall efficiency of the generation is about 93%. A flow of about 250 cm³/minute hydrogen gas is delivered to the laptop for use.

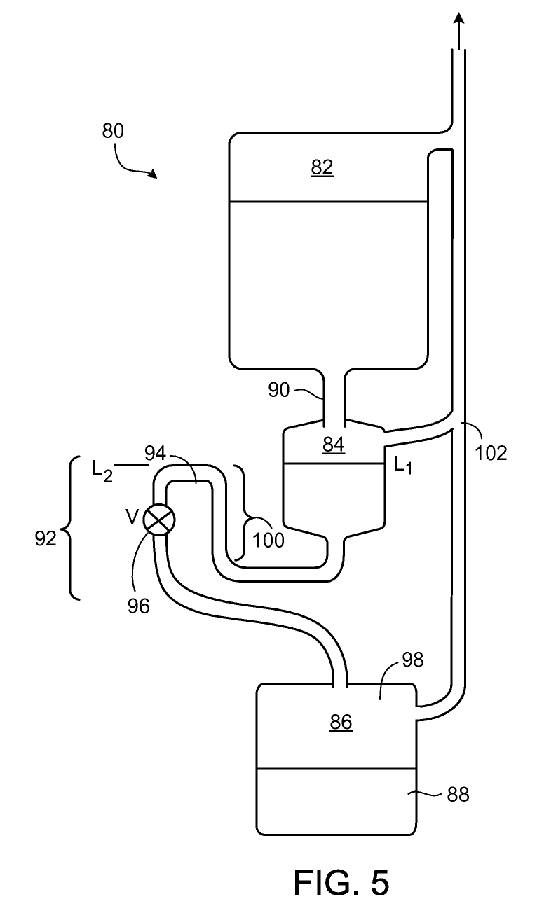

Referring to FIG. 5, instead of adding pellets into a liquid as described above, to generate hydrogen, an alternative hydrogen generator 80 adds a liquid at a desired rate to a solid hydrogen source in the form, for example, of a powder.

Hydrogen generator 80 includes a primary reservoir 82 that stores the liquid and a delivery reservoir 84 that receives the liquid from reservoir 82 and delivers the liquid to a hydrogen source reservoir 86 to react with a solid hydrogen source 88 contained in hydrogen source reservoir 86 to generate hydrogen. Hydrogen generator 80 also includes a fluid valve 90 between primary reservoir 82 and delivery reservoir 84 and a control unit 92 connected to delivery reservoir 84 and hydrogen source reservoir 86. Control unit 92 can be external electronics (not shown) or an internal pressure switch, which includes a U-tube 94 and a control valve 96 connected to U-tube 94. Fluid valve 90 controls the delivery of liquid, for example, rate of the delivery, form and size of the liquid, from primary reservoir 82 to delivery reservoir. In some embodiments, liquid is delivered into delivery reservoir in the form of droplets, having a size of about 0.02 cm³ to about 0.1 cm³. Primary reservoir 82, delivery reservoir 84, and hydrogen source reservoir 86 are connected, for example, by tube 102 to balance the pressure within hydrogen generator 80.

U-tube 94 allows control of adding the liquid from delivery reservoir 84 into hydrogen source reservoir 86 based on the pressure variation of the liquid in U-tube 94 and delivery reservoir 84. The liquid in delivery reservoir 84 has a free surface at level L₁ with respect to a reference height, for example, the ground. The bottom of “U” of U-tube 94 has a level L₂ with respect to the same reference height. In use, the liquid delivered from primary reservoir 82 fills delivery reservoir 84 and one arm 100 of U-tube 94 and the free surface level L₁ gradually reaches L₂. When more liquid is delivered and L₁ is larger than L₂, a sudden flow can start and the liquid in delivery reservoir 84 can be drained to reservoir 86 to react with the solid hydrogen source and generate hydrogen as described above. U-tube 94 allows an accumulation and release of a certain amount of liquid at a certain rate. The accumulated amount of liquid before release can be pre-selected, for example, by adjusting the level L₂ relative to the top of delivery reservoir 84 or by selecting a volume of delivery reservoir 84 or dimensions of U-tube 94. Reservoir 84 has a diameter, for example, of about 0.8 cm to about 1.2 cm, and a height, for example, of about 1.5 cm to about 3 cm. Reservoir 84 having such dimensions is suitable for accumulating a volume of about 0.5 cm³ to about 2 cm³ of liquid. This volume of liquid released to reservoir 86 can fully react with about 0.5 gram of solid hydrogen source, for example, sodium borohydride. U-tube 94 has a diameter, for example, of about 0.16 cm. The rate of the release of the accumulated liquid can be controlled, for example, by the speed of liquid delivery from primary reservoir 82 to delivery reservoir 84 and/or control valve 96.

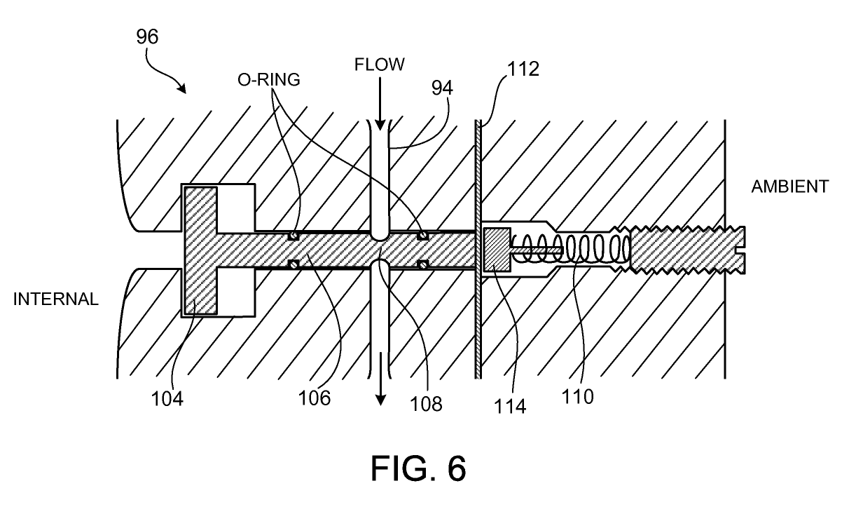

Referring to FIG. 6, control valve 96 controls liquid flow through U-tube 94 based on an internal pressure variation of buffer space 98, which is associated with the pressure of the hydrogen gas. Control valve 96 includes a plunger 104 having one end connected to tube 102 and exposed to an internal pressure of hydrogen gas in generator 80 (connection not shown in FIG. 5). Plunger 104 is movable along a direction different, for example, perpendicular to, the flow direction in U-tube 94 (partially shown) in response to a hydrogen gas pressure change within generator 80. A body 106 of plunger 104 includes a recessed portion 108. The dimensions of recessed portion 108 is smaller than the diameter of U-tube 94 so that when recessed portion 108 and a cross-section of U-tube 94 are aligned, liquid can flow through control valve 96 to reservoir 86. O-rings are attached to body 106 at various locations to prevent liquid seepage or creepage along body 106 and away from the U-tube 94. Control valve 96 also includes a pin 112 in connection with one end of a spring 110 and arranged adjacent to an end of body 106 of plunger 104. In some embodiments, an elastic membrane 112 made, for example, of silicon rubber, is placed between the end of body 106 and pin 112. Elastic membrane 12 can prevent leakage of the generated hydrogen. The state of spring 110 can be selected and plunger 104 moves to control the flow of liquid passing U-tube 94 in response to the variation in the internal pressure. The threshold internal pressure that allows recessed portion 108 to align with U-tube 94 to let flow pass can be pre-selected, for example, by adjusting the state of spring 110. When a large amount of hydrogen gas is generated and the internal pressure of buffer space 98 increases, plunger 104 is pushed toward spring 110 and body 106 blocks the flow of liquid. When hydrogen gas is consumed and the internal pressure of buffer space 98 decreases, plunger 104 is pushed back by spring 110 and recessed portion 108 aligns with a cross-section of U-tube 94 to allow the liquid to pass.

Referring back to FIG. 5, delivery reservoir 84 can contain a volume of about 2 cm³ of liquid. When the contained volume of liquid is fully used, about 3 liters of hydrogen can be generated. Hydrogen source reservoir 86 also includes a buffer space 98 having a size and functions similar to buffer space 70 discussed above.

The solid hydrogen source 88 and liquid can contain similar components to the solid hydrogen source and liquid used in hydrogen generator 10. The mechanism of generating hydrogen is also similar to that discussed above.

Other embodiments are in the following claims.

What is claimed is:

1. A hydrogen generator comprising:
a housing;
a solid hydrogen source;
a liquid including a proton source and a metal sulfate salt to which the solid hydrogen source is added to generate hydrogen; and
an outlet configured to deliver hydrogen to a hydrogen fuel cell.

2. The hydrogen generator of claim 1, wherein the metal sulfate salt comprises a transition metal sulfate salt.

3. The hydrogen generator of claim 2, wherein the transition metal sulfate salt is selected from the group consisting of cobalt sulfate, iron sulfate, copper sulfate, and nickel sulfate.

4. The hydrogen generator of claim 1, wherein the solid hydrogen source comprises a borohydride.

5. The hydrogen generator of claim 1, wherein the proton source comprises water.

6. The hydrogen generator of claim 1, wherein the solid hydrogen source is in the form of pellets.

7. The hydrogen generator of claim 6, wherein each pellet generates from about 50 cm³ to about 1500 cm³ of hydrogen when added into the liquid.

8. The hydrogen generator of claim 6, wherein each pellet comprises a borohydride having a weight percentage of between about 80% and about 99.9%.

9. A hydrogen generator comprising:
a housing;
a solid hydrogen source;
a liquid including from 0.2 M to 0.4 M of a metal salt and a proton source to which the solid hydrogen source is added to generate hydrogen; and
an outlet configured to deliver hydrogen to a hydrogen fuel cell.

10. The hydrogen generator of claim 9, wherein the metal sulfate salt comprises a transition metal sulfate salt.

11. The hydrogen generator of claim 9, wherein the solid hydrogen source comprises a borohydride and the proton source comprises water.

12. The hydrogen generator of claim 9, wherein the solid hydrogen source is in the form of pellets.

13. The hydrogen generator of claim 12, wherein each pellet generates from about 50 cm³ to about 1500 cm³ of hydrogen when added into the liquid.

14. A hydrogen generator comprising:
a housing;
pellets comprising a solid hydrogen source within the housing;
a reservoir containing_a liquid including a proton source and a metal salt to which the solid hydrogen source is added to generate hydrogen;
a magnetically activated actuator that automatically adds one of the pellets to the liquid in response to a variation in hydrogen pressure within the hydrogen generator; and
an outlet configured to deliver hydrogen to a hydrogen fuel cell.

15. The hydrogen generator of claim 14, the reservoir comprises a buffer space having a volume of about 50 cm³ to about 1500 cm³ above the liquid.

16. The hydrogen generator of claim 15, further comprising a first air passage from the buffer space to the outlet.

17. The hydrogen generator of claim 16, further comprising a second air passage connected to the first air passage and in communication with the magnetically activated actuator.

18. The hydrogen generator of claim 14, wherein the magnetically activated actuator comprises a first movable magnet having a first pole and a second movable magnet having a second pole facing the first pole, the first pole being the same as the second pole.

19. The hydrogen generator of claim 18, wherein the wherein the magnetically activated actuator further comprises an air cylinder having a movable plunger, the plunger comprising a first end connected to the first magnet.

20. The hydrogen generator of claim 19, wherein the plunger comprises a second end in communication with the generated hydrogen and the plunger and the first magnet move in response to the variation in hydrogen pressure.

21. The hydrogen generator of claim 18, wherein the magnetically activated actuator further comprises a movable cradle having a first end connected to the second magnet.

22. The hydrogen generator of claim 21, wherein the magnetically activated actuator further comprises a spring connected to a second end of the cradle.

23. The hydrogen generator of claim 21, wherein the housing comprises an open end and the cradle is configured to receive a pellet from the open end when the hydrogen pressure increases and to unload the a pellet into the reservoir when the hydrogen pressure decreases.

24. The hydrogen generator of claim 14, wherein the metal salt comprises a metal sulfate salt.

25. The hydrogen generator of claim 14, wherein the solid hydrogen source comprises a borohydride and the proton source comprises water.

26. The hydrogen generator of claim 14, wherein each pellet generates from about 50 cm³ to about 1500 cm³ of hydrogen when added into the liquid.

27. The hydrogen generator of claim 14, wherein the liquid includes 0.2 M to 0.4 M of the metal salt.

28. The hydrogen generator of claim 14, wherein the housing is in the shape of a tube and the pellets are stacked vertically in the housing.

29. The hydrogen generator of claim 14, wherein hydrogen is delivered from the outlet at a rate of about 250 cm³/minute.

30. The hydrogen generator of claim 14, wherein the hydrogen fuel cell can provide a power supply of about 20 W to about 25 W to a laptop computer.

31. A hydrogen generator comprising:
a housing;
a solid hydrogen source;
a liquid including a metal salt and a proton source to which the solid hydrogen source is added to generate hydrogen, a weight ratio between the solid hydrogen source and the liquid between 1:1 and 1:5; and
an outlet configured to deliver hydrogen to a hydrogen fuel cell.

32. The hydrogen generator of claim 31, wherein the solid hydrogen source comprises sodium borohydride and for each cubic centimeter of liquid stored in the hydrogen generator, about 0.2 gram to about 0.7 gram of solid hydrogen source is stored in the hydrogen generator.

33. The hydrogen generator of claim 31, wherein the solid hydrogen source comprises sodium boron hydride and the proton source comprises water.

34. The hydrogen generator of claim 31, wherein the liquid includes 0.2 M to 0.4 M of the metal salt.

35. A hydrogen generator comprising:
a housing;
a solid hydrogen source within a chamber in the housing;
a first reservoir including a liquid including a metal salt and a proton source that when combined with the solid hydrogen source generates hydrogen and an outlet valve that releases the solution in a controlled manner;
a second reservoir that receives the liquid from the first reservoir through the outlet valve;
a control valve associated with the second reservoir that controls release of the liquid from the second reservoir to the chamber when the solution in the second reservoir reaches a certain height; and
an outlet configured to deliver hydrogen to a hydrogen fuel cell.

36. The hydrogen generator of claim 35, further comprising a U-tube in communication with the second reservoir and the chamber.

37. The hydrogen generator of claim 36, wherein the control valve is in communication with the U-tube to control flow of the liquid from the second reservoir to the chamber.

38. The hydrogen generator of claim 35, wherein the control valve is in communication with an internal pressure of the hydrogen generator and controls the release of the liquid in response to a variation in the internal pressure.
